(19) United States
(12) Patent Application Publication
(10) Pub. No.: US 2005/0243457 A1
(43) Pub. Date: Nov. 3, 2005

(54) Method and apparatus for degaussing write head in a disk drive

(75) Inventors: Manabu Akamatsu, Ome-shi (JP); Kazuhito Shimomura, Fussa-shi (JP); Yuji Sakai, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/087,637

(22) Filed: Mar. 24, 2005

(30) Foreign Application Priority Data
Apr. 28, 2004 (JP) JP 2004-134496

(51) Int. Cl. G11B 5/02; G11B 5/03

(52) U.S. Cl. 360/55; 360/66

(57) ABSTRACT

A disk drive which includes a head amplifier having a function of degaussing a magnetic head effective to suppression of an EAW phenomenon is disclosed. The head amplifier includes a degaussing controller which performs switching from write operation to degaussing operation, a write driver which outputs degaussing current necessary for the degaussing operation, and a current control unit which sets a current waveform of the degaussing current.

### CROSS-REFERENCE TO RELATED APPLICATIONS

This application is based upon and claims the benefit of priority from prior Japanese Patent Application No. 2004-134496, filed Apr. 28, 2004, the entire contents of which are incorporated herein by reference.

### BACKGROUND OF THE INVENTION

1. Field of the Invention

The present invention relates to a perpendicular magnetic recording type of disk drive, particularly to a head degaussing technology for degaussing a write head.

2. Description of the Related Art

Generally, in a perpendicular magnetic recording type of disk drive, an erase after write (EAW) phenomenon caused by residual magnetization in a write head is generated when write operation (perpendicular magnetic recording) is ended. The EAW phenomenon is one in which data recorded on a disk medium (hereinafter referred to as disk) is erased.

When the EAW phenomenon is generated, after recording is performed to a data sector on the disk by the write head, all or some of pieces of data recorded in the next data sectors subsequent to the data sector is erased. If the next data sector is an access object data sector, a read error occurs when the data recorded in the next data sector is read by a read head. If the next data sector is a servo sector, since the servo data is erased, a positioning error occurs when positioning control of the head is performed on a cylinder (track) including the servo sector.

The EAW phenomenon includes a case where all the pieces of magnetization on the disk are orientated toward one direction and the recorded data is completely erased (for the sake of convenience, referred to as phenomenon A) and a case where part of the pieces of magnetization on the disk is orientated toward one direction and a reproduction amplitude is decreased when the recorded data is read by the read head (for the sake of convenience, referred to as phenomenon B).

A head degaussing method of degaussing residual magnetization of a write head is effective as a method of suppressing the EAW phenomenon (for example, see Japanese Patent No. 2842351).

In the head degaussing method, usually a current waveform is used as degaussing current for a write head. In the current waveform, the degaussing current is gradually decreased in a logarithmic-function form. However, it is confirmed that the sufficient suppression effect is not obtained by the method for the EAW phenomenon corresponding to the phenomenon B while the method is effective to the suppression of the EAW phenomenon corresponding to the phenomenon A. The current waveform having the narrowing-down-shaped envelope, in which the degaussing current is gradually decreased and rapidly decreased from a certain threshold, is effective to the EAW phenomenon corresponding to the phenomenon B.

In the logarithmic-function-shaped degaussing current waveform, even if the EAW phenomenon corresponds to the phenomenon A, sometimes the sufficient suppression effect cannot be obtained due to characteristics of the write head for use in the perpendicular magnetic recording type of disk drive.

### BRIEF SUMMARY OF THE INVENTION

In accordance with an aspect of the present invention, there is provided a disk drive which has facilities for degaussing a magnetic head effective to suppression of an EAW phenomenon.

The disk drive comprises: a write head which performs perpendicular magnetic recording according to write data to be recorded on a disk medium during write operation; a write driver which outputs recording current according to the write data to the write head during the write operation, and which outputs degaussing current to the write head during degaussing operation of degaussing residual magnetization in the write head; a current control unit which variably sets a current value or a degaussing current waveform of the degaussing current outputted from the write driver during the degaussing operation; and a degaussing controller which controls the degaussing current outputted from the write driver by outputting the write data to the write driver during the write operation and by outputting degaussing data during the degaussing operation.

### BRIEF DESCRIPTION OF SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a main part of a disk drive according to an embodiment of the invention;

FIG. 2 is a block diagram showing a main part of a head amplifier according to the embodiment;

FIGS. 3A to 3F are timing charts for explaining operation of the head amplifier according to the embodiment;

FIG. 4 is a view for explaining degaussing operation according to the embodiment;

FIG. 5 shows a specific example of data stored in a register of a current control unit according to the embodiment;

FIG. 6 shows a specific example of data stored in a register of a degaussing control unit according to the embodiment;

FIGS. 7A to 7F are views for explaining an example of a degaussing current waveform according to the embodiment; and

FIGS. 8A to 8E are views for explaining a method of inspecting an EAW phenomenon according to the embodiment.

### DETAILED DESCRIPTION OF THE INVENTION

Referring now to the accompanying drawings, an embodiment of the invention will be described.

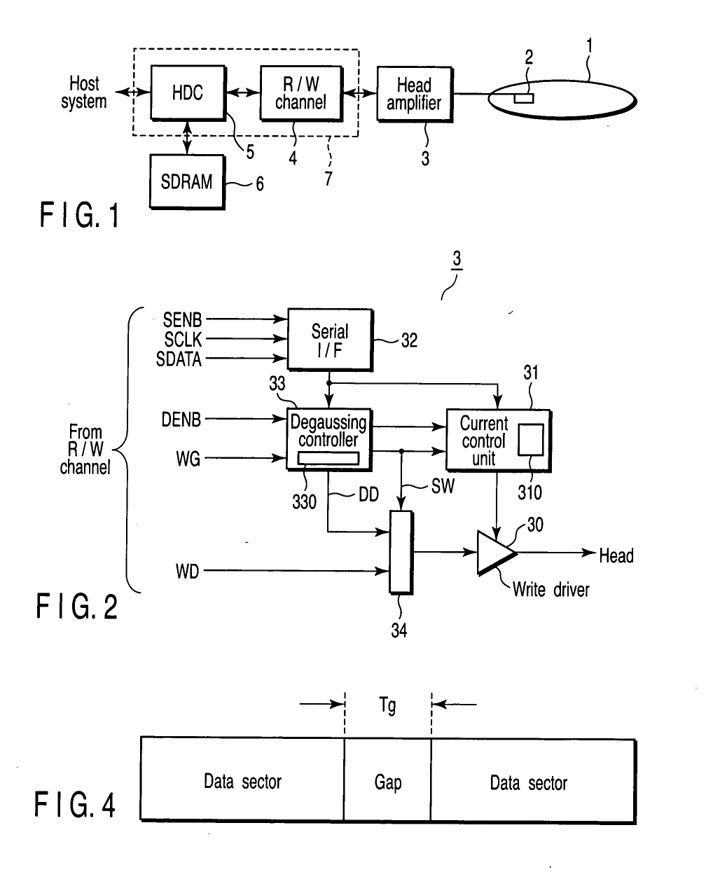

FIG. 1 is a block diagram showing a main part of a perpendicular magnetic recording type of disk drive according to an embodiment of the invention. FIG. 2 is the block diagram showing a main part of a head amplifier according to the embodiment.

(Configuration of Disk Drive)

The disk drive according to the embodiment includes a disk 1 in which data is recorded by perpendicular magnetic recording, a magnetic head 2, a head amplifier 3, a read/write (R/W) channel 4, a disk controller (HDC) 5, and a buffer memory (SDRAM) 6.

The magnetic head 2 includes a write head which can perform the perpendicular magnetic recording to the disk 1, and a read head which reads the recorded data from the disk 1. The magnetic head 2 is configured to be held by an actuator (not shown) and moved in a radial direction on the disk 1.

The R/W channel 4 is a circuit which performs various kinds of signal processing necessary for the data recording and data reproduction. The R/W channel 4 performs input/output of a signal in/from the head amplifier 3 according to the embodiment. The HDC 5 is an interface between the disk drive and a host system (for example, personal computer and digital equipment), and the HDC 5 inputs and outputs read/ write data or various commands. For example, the buffer memory 6 is formed by, for example, synchronous DRAM (SDRAM). The buffer memory 6 is controlled by the HDC 5, and the read data or the write data is temporarily stored in the buffer memory 6.

The R/W channel 4 and the HDC 5 are integrated in a one-chip integrated circuit (LSI) 7, and the LSI 7 is mounted on a drive circuit board. On the other hand, the head amplifier 3 is mounted on a flexible printed circuit board (FPC) arranged in the vicinity of the magnetic head 2.

(Configuration of Head Amplifier)

The head amplifier 3 can roughly be divided into a write amplifier and a read amplifier. Because the embodiment is related to the write amplifier, the description of the read amplifier is omitted.

As shown in FIG. 2, the write amplifier includes a write driver 30, a current control unit 31 which is of a write current source, a serial interface (I/F) 32, a degaussing controller 33, and a data switching device 34.

The write driver 30 converts a recording signal of write data WD or degaussing data DD into recording current to output the recording signal to the write head. In the embodiment, for the sake of convenience, in the degaussing operation, the recording current according to the degaussing data DD is referred to as degaussing current.

The current control unit 31 provides the recording current or the degaussing current of the write driver 30 according to the write operation in which the write data WD is recorded or the degaussing operation. The current control unit 31 includes a register 310 which sets data for controlling the recording current or the degaussing current (see FIG. 5).

The serial I/F 32 receives an enable signal (SENB), a click signal (SCLK), and serial data (SDATA) which are transferred from the R/W channel 4. The serial I/F 32 sets the serial data (SDATA) in the register 310 of the current control unit 31 and a register 330 of the degaussing controller 33.

The degaussing controller 33 receives a write gate WG transferred from the R/W channel 4 and controls the degaussing operation which is performed after the write operation as mentioned later. The degaussing controller 33 has the register 330 and holds data necessary for the control of the degaussing operation (see FIG. 6). Further, the degaussing controller 33 controls the data switching device 34 to switch the write data WD to the degaussing data DD during the degaussing operation, the write data WD being transferred to the write driver 30 during the write operation.

(Operation of Write Amplifier)

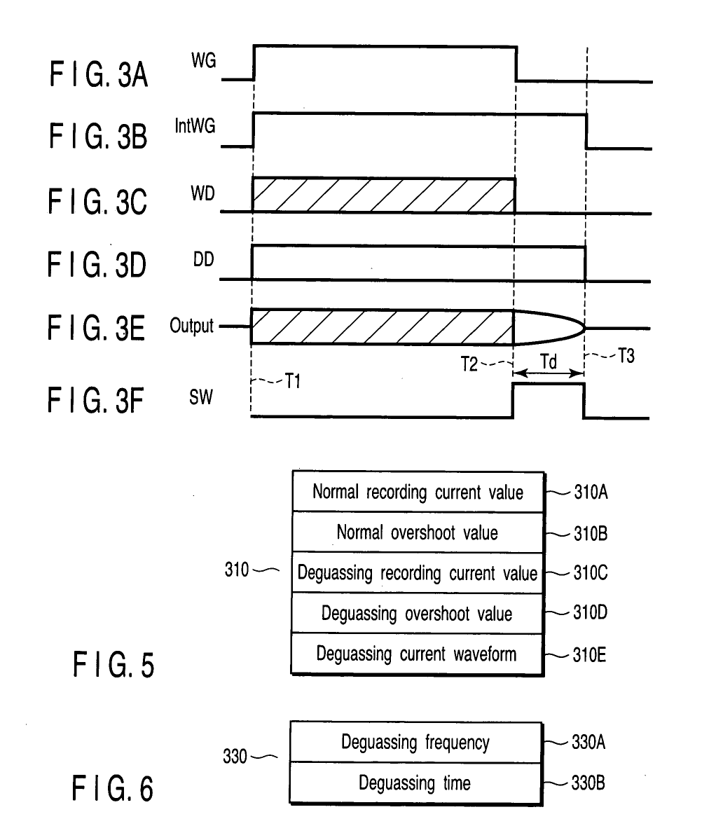

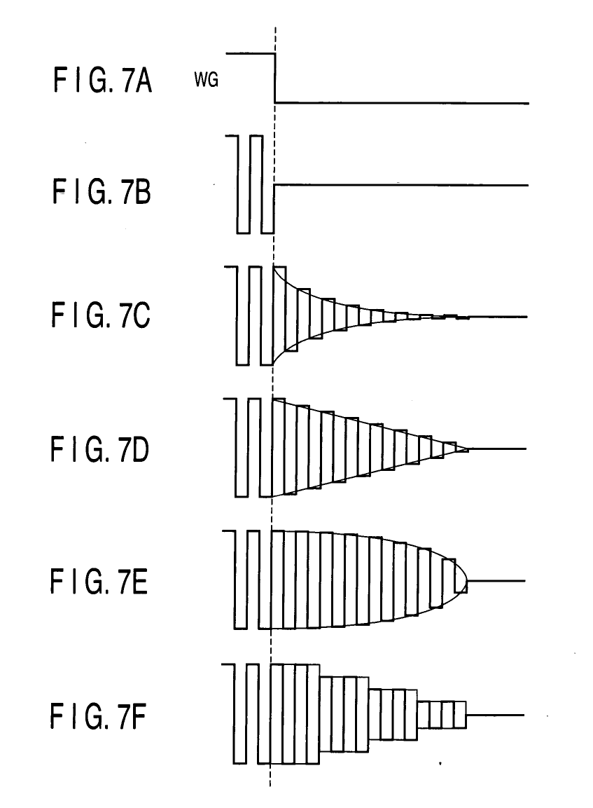

Referring to FIGS. 3A to 3F and FIGS. 7A to 7F, the operation of the write amplifier included in the head amplifier 3 of the embodiment will be described below.

In the register 310 of the current control unit 31, as shown in FIG. 5, normal recording current 310A, normal overshoot 310B, degaussing recording current value (degaussing current value) 310C, degaussing overshoot 310D, and data 310E concerning a degaussing recording current waveform are set as the serial data (SDATA) from the serial I/F 32.

On the other hand, in the register 330 of the degaussing controller 33, as shown in FIG. 6, data 330A for indicating a frequency of the degaussing data DD (degaussing frequency) and data 330B for indicating degaussing time of the degaussing operation are set as the serial data (SDATA) from the serial I/F 32.

Then, the operation of the write amplifier, particularly the operations of the degaussing controller 33 and the write driver 30 will be described referring to timing charts shown in FIGS. 3A to 3F.

In the disk drive, as shown in FIG. 3A, the recording (write operation) of the write data WD (data modulated by the R/W channel 4) is started in a specified data sector (for example, a data sector on the left side shown in FIG. 4) on the disk 1 at timing at which a logic level of the write gate WG is changed from Low to High (time T1).

As shown in FIG. 3B, the degaussing controller 33 generates an internal write gate IntWG. The internal write gate IntWG becomes the High level in synchronization with the write gate WG, and is changed to the Low level when the degaussing operation (time Td) is ended.

Further, as shown in FIG. 3F, the degaussing controller 33 generates a switching signal SW. The switching signal SW is in the Low level when both the write gate WG and the internal write gate IntWG are in the High level, and the switching signal SW becomes the High level when only the internal write gate IntWG is in the High level. The degaussing controller 33 outputs the switching signal SW to the data switching device 34 and the current control unit 31.

When the switching signal SW is in the Low level, the data switching device 34 selects the write data WD to output the write data WD to the write driver 30. The current control unit 31 drives and controls the write driver 30 at the normal recording current value 310A and the normal overshoot 310B which are set in the register 310.

As shown in FIG. 3E, the write driver 30 outputs the recording current (normal recording current value 310A) according to the write data WD to the write head included in the magnetic head 2 in a valid interval of the write gate WG (interval between T1 and T2) (Output).

As shown in FIG. 4, the write head performs the perpendicular magnetic recording onto, for example, the data sector on the left side in the figure on the disk 1 according to the write data WD.

(Degaussing Operation)

When the write gate WG is changed to the Low level after the write operation is ended, as shown in FIG. 3F, the degaussing controller 33 outputs the switching signal SW for indicating that only the internal write gate IntWG is enabled (High level). As shown in FIG. 3D, the degaussing controller 33 generates and outputs the degaussing data DD in synchronization with the internal write gate IntWG. It is also possible that the degaussing controller 33 is configured to generate and output the degaussing data DD at timing (T2) of the degaussing interval (Td).

The data switching device 34 selects the degaussing data DD outputted from the degaussing controller 33 according to the switching signal SW, and outputs the degaussing data DD to the write driver 30. At this point, the degaussing controller 33 outputs the degaussing data DD at a frequency according to the degaussing frequency data 330A set in the register 330.

The current control unit 31 detects the switching from the write operation to the degaussing operation by the switching signal SW, and the current control unit 31 drives and controls the write driver 30 based on the degaussing current 310C, the degaussing overshoot 310D, and the degaussing current waveform data 310E which are set in the register 310.

As shown in FIG. 3E, the write driver 30 outputs the degaussing current according to the degaussing data DD to the write head during the interval between the time (T2) when the write gate WG is changed to the Low level and the time (T3) when the degaussing time (Td) is ended.

As shown in FIG. 3B, the degaussing controller 33 holds the internal write gate IntWG at High level based on the degaussing time data 330B only for the degaussing time (Td) since the time (T2) when the write gate WG is changed to the Low level.

Accordingly, as shown in FIG. 3E, the degaussing controller 33 outputs the degaussing data DD from the time (T2) when the degaussing operation is started, and stops the output of the degaussing data DD at the time (T3) when the degaussing time (Td) is ended.

As shown in FIG. 4, using the degaussing current provided from the write driver 30, the write head performs the perpendicular magnetic recording to a gap region between the data sectors according to the degaussing data DD. In this case, usually a time (Tg) corresponding to the gap region has the sufficiently long time relative to the degaussing time (Td). Accordingly, the degaussing operation with the write head does not affect the data sector in which the write data WD should be recorded.

As described above, after the write operation is performed to the data sector, the write amplifier of the embodiment provides the degaussing current to the write head to perform the degaussing operation. The perpendicular magnetic recording by the degaussing operation (corresponding to a kind of dummy write operation) is performed to the gap region between the data sectors.

In the embodiment, the current control unit 31 controls the degaussing current waveform outputted from the write driver 30 based on the degaussing current waveform data 310E set in the register 310.

As shown in a specific example of FIGS. 7C to 7F, the current control unit 31 sets the degaussing current waveform. In the degaussing current waveform, the recording current value is gradually decreased in a narrowing-down shape selected from the narrowing-down shapes of envelopes of the degaussing current. Namely, the narrowing-down shapes include a logarithmic-function shape shown in FIG. 7C, a linear shape shown in FIG. 7D, a parabolic shape shown in FIG. 7E, and a step shape shown in FIG. 7F.

FIG. 7B shows an output state of the write driver 30 in the case where the write gate WG is changed to the Low level as shown in FIG. 7A not to perform the degaussing operation (degaussing function is disabled). For example, the degaussing controller 33 controls the enabled state or the disabled state of the degaussing function by, for example, a degaussing enable signal DENB from a CPU (a main controller of the drive (not shown)) of the disk drive.

In the embodiment, in the degaussing operation for degaussing residual magnetization in the write head after the write operation, as shown in FIGS. 7C to 7F, the degaussing current waveform can variably be set based on the degaussing current waveform data 310E set in the register 310 of the current control unit 31. Therefore, the head degaussing function which obtains the sufficient suppression effect against the EAW phenomenon can be realized by setting the degaussing current waveform based on the EAW phenomenon characteristics or the write head characteristics.

(Method of Inspecting EAW Phenomenon)

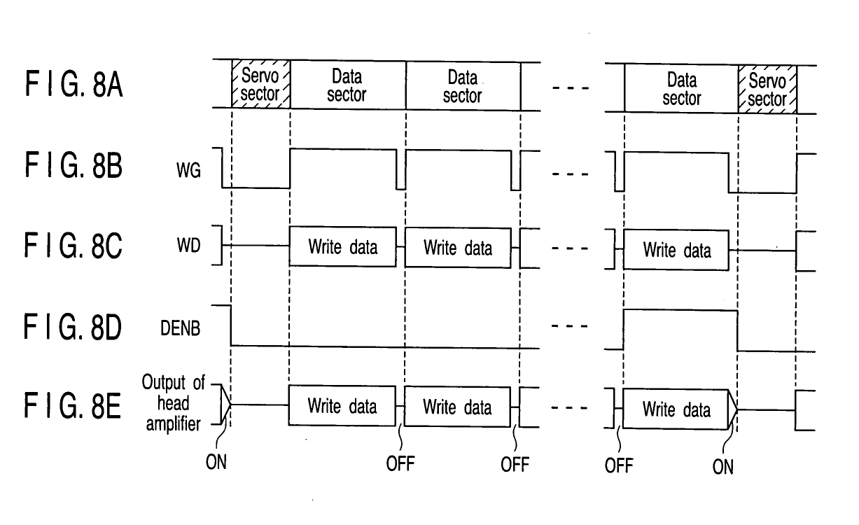

FIGS. 8A to 8E are views for explaining a method of inspecting the EAW phenomenon using the head amplifier 3 of the embodiment.

FIG. 8E shows the output of the write amplifier (output of the write driver 30), and in FIG. 8E, “ON” means that the degaussing function is enabled, and “OFF” means that the degaussing function is disabled. FIG. 8A shows a data format on the disk 1.

FIGS. 8B to 8D show output timings of the write gate WG, the write data WD, and the degaussing enable signal DENB, respectively.

In the case where the EAW phenomenon is inspected using the head amplifier 3 of the embodiment, when the EAW phenomenon is suppressed while the degaussing function is always enabled, the inspection of the EAW phenomenon cannot efficiently be performed. On the other hand, when the inspection is performed while the degaussing function is always disabled, sometimes the disk drive cannot be operated because the EAW phenomenon erases the servo data in the servo sector.

Therefore, as shown in FIG. 8E, in the method of the embodiment, the degaussing function is enabled only in the case where the recording (write operation) is performed into the immediately preceding data sector of the servo sector, and the degaussing function is disabled in the case where the recording is performed into other data sectors. Accordingly, the servo data in the servo sector is not erased due to the EAW phenomenon, and the inspection of the EAW phenomenon can efficiently be performed.

As described above, according to the embodiment, the setting of the degaussing current waveform can be changed according to the EAW phenomenon characteristics, the characteristics of the perpendicular magnetic recording type of write head, and the like, so that the head degaussing function effective to the suppression of the EAW phenomenon can be realized.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A disk drive comprising:
a write head which performs perpendicular magnetic recording according to write data to be recorded on a disk medium during write operation;
a write driver which outputs recording current according to the write data to the write head during the write operation, and which outputs degaussing current to the write head during degaussing operation of degaussing residual magnetization in the write head;
a current control unit which variably sets a current value or a degaussing current waveform of the degaussing current outputted from the write driver during the degaussing operation; and
a degaussing controller which controls the degaussing current outputted from the write driver by outputting the write data to the write driver during the write operation and by outputting degaussing data during the degaussing operation.

2. The disk drive according to claim 1, wherein the degaussing controller controls to cause the degaussing current to be outputted from the write driver to the write head only for a time corresponding to a specified degaussing time after the write operation is ended.

3. The disk drive according to claim 1, wherein the current control unit includes a register which holds data for setting the current value of the degaussing current, and the current control unit controls the current value of the degaussing current outputted from the write driver based on the data.

4. The disk drive according to claim 1, wherein the current control unit includes a register which holds data for setting the degaussing current waveform, and the current control unit controls the current waveform of the degaussing current outputted from the write driver based on the data.

5. The disk drive according to claim 1, wherein the current control unit includes a register which holds data for setting the degaussing current waveform, and the current control unit sets an envelope shape of the degaussing current waveform outputted from the write driver based on the data.

6. The disk drive according to claim 1, wherein the current control unit includes a register which holds data for setting the degaussing current waveform, and the current control unit sets an envelope narrowing-down shape in any one of a logarithmic-function shape, a linear shape, a parabolic shape, and a step shape as the degaussing current waveform outputted from the write driver based on the data.

7. The disk drive according to claim 1, wherein the degaussing controller includes a register which holds data for controlling output of the degaussing data, and the degaussing controller controls an output time of the degaussing current outputted from the write driver based on the data.

8. A head amplifier device for a disk drive having a write head for perpendicular magnetic recording on a disk medium, comprising:
a write driver which outputs recording current according to write data to the write head during write operation of performing perpendicular magnetic recording onto the disk medium, and which outputs degaussing current to the write head during degaussing operation of degaussing residual magnetization in the write head; and
a degaussing controller which controls to cause the degaussing current of a degaussing current waveform to be outputted from the write driver to the write head during the. degaussing operation, the degaussing current waveform being variably set from the outside.

9. The head amplifier device according to claim 8, wherein the degaussing controller includes a register which holds data for indicating a degaussing time which is of a duration of the degaussing operation, and the degaussing controller controls to cause the degaussing current to be outputted from the write driver to the write head only for the degaussing time during the degaussing operation.

10. The head amplifier device according to claim 8, wherein the degaussing controller transfers the write data to the write driver based on a write gate which indicates timing of the write operation, performs switching to transfer degaussing data to the write driver at the time when the degaussing operation is started after the write operation is ended, and controls to cause the degaussing current to be outputted from the write driver to the write head based on the degaussing data.

11. The head amplifier device according to claim 8, further comprising a current control unit including a register which holds data for variably setting a current value of the degaussing current, wherein
the current control unit controls the current value of the degaussing current outputted from the write driver based on the data during the degaussing operation.

12. The head amplifier device according to claim 8, further comprising a current control unit including a register which holds data for variably setting the degaussing current waveform of the degaussing current, wherein the current control unit controls the degaussing current waveform outputted from the write driver based on the data during the degaussing operation.

13. The head amplifier device according to claim 8, further comprising a current control unit including a register which holds data for variably setting a recording current value, a degaussing current value, and the degaussing current waveform, wherein
the current control unit controls the recording current value outputted from the write driver during the write operation based on the data, and controls the degaussing current value or the degaussing current waveform outputted from the write driver during the degaussing operation.

14. The head amplifier device according to claim 8, further comprising a current control unit including a register which holds data for variably setting the degaussing current waveform whose envelope narrowing-down shape has any one of a logarithmic-function shape, a linear shape, a parabolic shape, and a step shape, wherein
the current control unit sets the envelope narrowing-down shape in any one of the logarithmic-function shape, the linear shape, the parabolic shape, and the step shape as the degaussing current waveform outputted from the write driver based on the data during the degaussing operation.
